(19) United States
(12) Patent Application Publication
(10) Pub. No.: US 2024/0074362 A1
(43) Pub. Date: Mar. 7, 2024

(54) APPARATUS AND RELATED METHOD FOR GLOBAL WEATHER MODIFICATION AND PRECEPITATION ENHANCEMENT

(71) Applicant: Konstantin A. Borisov, Avon, CT (US)

(72) Inventor: Konstantin A. Borisov, Avon, CT (US)

(21) Appl. No.: 17/929,719

(22) Filed: Sep. 5, 2022

(51) Int. Cl. A01G 15/00

(52) U.S. Cl. CPC A01G 15/00

(57) ABSTRACT

The present invention provides an apparatus for weather modification and related method. The invention offers a solution to enhance the precipitation in arid regions of the planet whereas the enhancement of the precipitation and weather modification is used for irrigation or comfort. The invention is based on the release of charge carriers to ambient and utilization of the electromagnetic field of the planet for their distribution around the planet which brings moisture through the ionic or electric wind and rainfall with condensation. The invention provides other benefits such as low cost and low maintenance light as an alternative to expensive, high maintenance, outdoor light options through wireless solution. The apparatus is also be configured to affect the weather globally and slow down the thinning planet ice caps, with the benefit of slowing down or lowering the rising sea levels.

### FIELD OF THE INVENTION

The present invention relates generally to weather modification and more specifically to rain enhancement.

### BACKGROUND OF THE INVENTION

Many regions of the planet have an arid climate, characterized by limited rainfall and high air temperatures. Production of agriculture crops in such regions is restricted and limited mainly by the availability of freshwater resources. The present invention enhances precipitation in such arid regions, offering more opportunities for crop production and farming.

The present invention offers other benefits, including comfort cooling, illumination/outdoor lighting with no hard wires, and slowing down the planet ice caps melting, induced by global warming climates.

### SUMMARY OF THE INVENTION

An apparatus for weather modification and precipitation enhancement and method to enhance rainfall in arid regions of the planet. The weather modification is achieved through distribution of the electrically non-neutral charge carriers across the planet, governed by the electromagnetic field of the planet. The embodiments include various methods for emission of the charge carriers from the apparatus, whereas the said released carriers force air circulation around the planet, and moisture release through condensation. The corresponding method for the precipitation enhancement is also presented.

### BRIEF DESCRIPTION OF THE DRAWINGS

FIG. 1 is a front view of a cross-section of an embodiment of the present invention.

FIG. 2 is a front view of a cross-section of an embodiment of the present invention.

FIG. 3 is a front view of a chamber of an apparatus of an embodiment of the present invention.

FIG. 4 is a perspective view of a charge carrier trajectory of an embodiment of the present invention.

FIG. 5 is a perspective view of a segment of a charge carrier trajectory of an embodiment of the present invention.

FIG. 6 is a perspective view of a charge carrier trajectory of an embodiment of the present invention.

FIG. 7 is a flow diagram of a created air flow of an embodiment of the present invention.

FIG. 8 is a front view of an obelisk for wireless light creation of an embodiment of the present invention.

FIG. 9 is a flowchart of a method for weather modification and precipitation enhancement of an embodiment of the present invention.

### DETAILED DESCRIPTION OF THE INVENTION

All illustrations of the drawings are for the purpose of describing selected versions of the present invention and are not intended to limit the scope of the present invention.

One or more illustrative embodiments of the disclosure are described herein. Such embodiments are merely illustrative of the scope of this disclosure and are not intended to be limiting in any way. Accordingly, variations, modifications, and equivalents of embodiments disclosed herein are also within the scope of this disclosure.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

As described in the subsequent sections of this disclosure, the present invention and related method are based on the properties of the charge carriers and their trajectories in the electromagnetic field of the planet when they are released in the atmosphere.

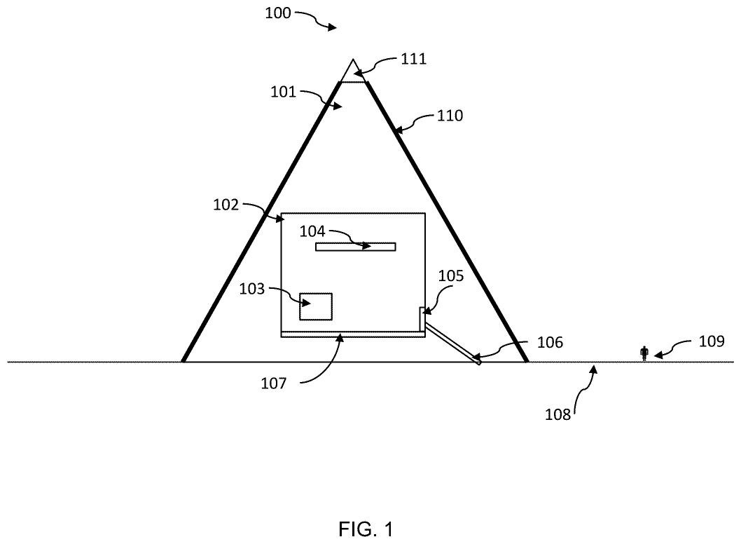

FIG. 1 is a front view of a cross-section of an embodiment of the present invention. An example arrangement for the apparatus in accordance with one or more embodiments of the disclosure is shown. Apparatus 100 includes inner structure 101 with chamber 102. Chamber 102 is used to produce electric charger carriers, hereinafter referred to as “charge carriers.” Such charge carriers include electrons, protons, positrons, alpha particles, ions, and generally any other elementary particles which are not electrically charge neutral. The electrically neutral charge particles (e.g. air molecules), hereinafter, will be referred as “charge neutral.”

In one embodiment, inlet 106 is used to channel medium to the chamber, whereas the medium is in the gaseous, solid, or liquid form and used in such embodiment as a source of charge carriers. Valve 105 is used to control the medium inflow to chamber 102. In one embodiment, ionizer 103 is a high voltage device and used to ionize the medium present in chamber 102 to produce the charge carriers. Voltage source 107 is used to provide an electric force to direct charge carriers to the peak of the apparatus, where emitter 111 is located. The orientation of voltage source 107 is such that the positive terminal of voltage source 107 faces earth 108 and the negative terminal of voltage source 107 faces the peak of the apparatus, whereas the charge carriers are of negative polarity (e.g. electrons). Electromagnetic device 104 is used to create an electromagnetic pulse to push charge carriers out of the apparatus through emitter 111 at non-zero initial velocity. To limit the emission of the charge carries from sides 110 of the apparatus, a layer of insulation is added on sides 110. Person 109 is shown next to the apparatus.

Inner structure 101 is be made of material that has non-zero ionic conductivity, including metals, natural or artificial polymers, or stones. In one embodiment, the shape of the apparatus is pyramidal. In another embodiment, the apparatus has an obelisk shape or any other shape allowing for concentration of the charge carriers at the emitter, allowing for their emission. In another embodiment, a large antenna type shape is used.

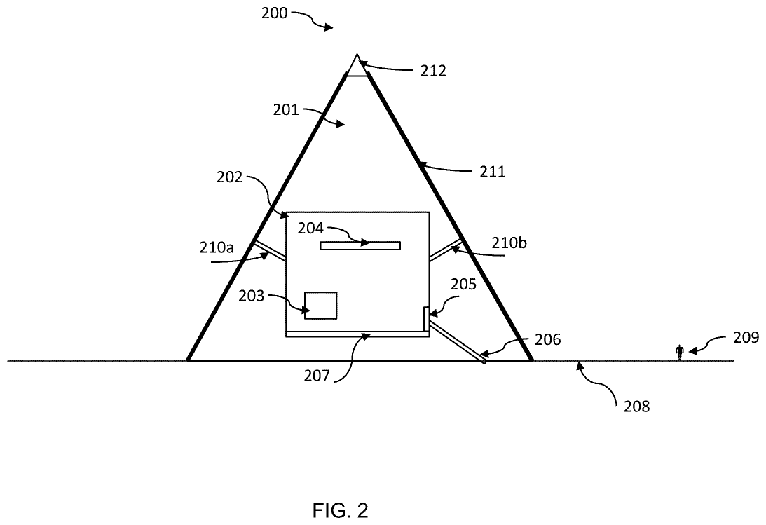

FIG. 2 is a front view of a cross-section of an embodiment of the present invention. An example arrangement for apparatus 200 in accordance with an embodiment of the present invention is shown. Inner core 201 contains chamber 202. The embodiment has piezoelectric device 204. As such any exposure to mechanical stress or deformation, device 204 creates an electric field, which is used in this embodiment as a force to push charge carriers out of emitter 212 with non-zero initial velocity. Channel 206 is connected to apparatus 200 and is used in this embodiment to supply medium to the chamber.

The preferred materials for the medium have the following properties: low ionization energy, low atomic mass, combine easily with oxygen (O), easily combustible when combined with oxygen, low activation energy for combustion to begin, non-toxic, non-radioactive, and is available in abundance. Hydrogen (H) is an example of gaseous medium, whereas mercury (M) in liquid form is an example of liquid medium, and generally solid elements from the periodic table can be considered for the source medium. Chemical components with lowest ionization energy, also listed in the periodic table, would be the preferred choice for medium for the charge carriers.

Various methods may be used to produce the charge carriers from the medium that includes but not limited to, ionization, pressure, heat, exposure to the light, or nuclear decay.

In one non-limiting example, the medium is hydrogen supplied through channel 206 to chamber 202, with the amount of the medium controlled by valve 205. Mixing hydrogen with oxygen occurs in chamber 202. Channels 210a and 210b lead to the outside of apparatus 200, supplying oxygen to the chamber for mixing with the supplied gaseous medium for combustion. Voltage source 207 is used to provide an electric force to direct charge carriers to the peak of apparatus 200, where emitter 212 is located. The orientation of voltage source 207 is such that positive terminal of the voltage source faces earth 208 and the negative terminal of voltage source 207 faces the peak of the apparatus. Insulation 211 is optionally added in a layer to the sides of the structure to avoid leaking of the charge carrier from the sides to ambient. Ionizer 203 ignites the gas mixture inside the chamber to combust. In this embodiment, piezoelectric device 204 deforms under the mechanical stress due to a pressure wave from combustion, creating an electric field and force to push charge carriers out of emitter 212. Person 209 is shown next to the apparatus.

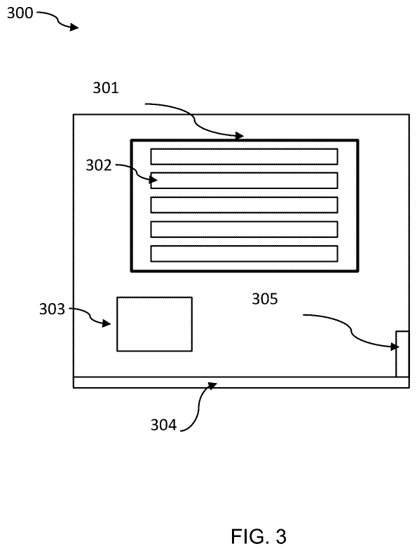

FIG. 3 is a front view of chamber 300 of an apparatus of an embodiment of the present invention. In this embodiment, chamber 300 contains assembly 301, comprising individual piezoelectric elements 302. In this embodiment individual piezoelectric elements 302 are deformed in sequence starting from one at the bottom and progressing to the top in sequence, where each piezoelectric element gives electric field as deformed and velocity to the charge carriers released by emitter 212. All individual piezoelectric units may also be activated all together at once. Valve 305 is used for controlling the amount of medium inflow to chamber 300. Ionizer 303 is a high voltage device, which is used to ionize the medium present in chamber 300 to produce the charge carriers. A high voltage discharge in ionizer 303 causes a spark that is used to initiate combustion inside chamber 300. Voltage source 304 is placed in chamber 202 to force the charge carriers to collect at the upper portion of the apparatus at or near emitter.

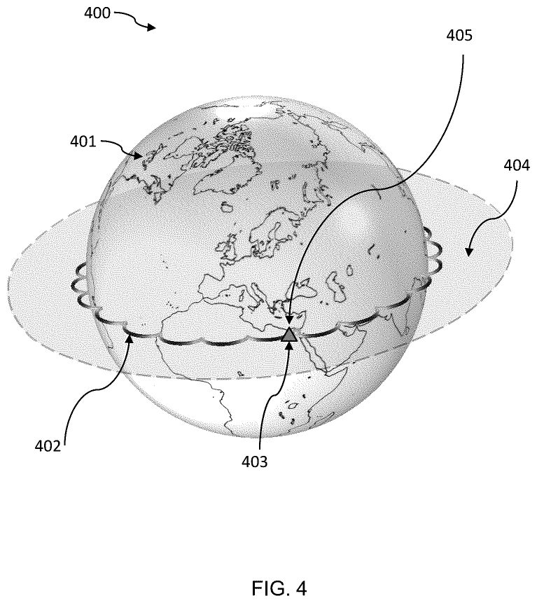

FIG. 4 shows system 400. The charge carriers released from apparatus 403 placed at the location Gan-Eden 405. The planet is shown as 401. The charge carriers move along arc shaped trajectory 402 as they are released from apparatus 403. The trajectory of the charge carriers released from the apparatus is mainly deterministic and is defined by the Lorentz force acting on the charge carriers at the presence of the electromagnetic field of the planet, directing the charge carriers to move along the plane of the magnetic equator 404. In the illustrated example, two axis points for the planet magnetic field dipole are located at 59° 53′ north latitude and 138° 36′ west longitude and at 59° 53′ south latitude and 41° 24′ east longitude. This axis points make the plane of the magnetic equator intersect the surface of planet 401 at location 405. As the charge carriers move along trajectory 402, they complete a revolution around the planet. Trajectory of charge carriers 402 may vary and is dependent on a number of factors including: intensity of the electric and magnetic fields of the planet, the direction of the magnetic field vector, velocity and mass of the charge carriers, air density, direction of the charge carriers released from the emitters, and others.

In this embodiment, the apparatus 403 provides initial energy to accelerate the charge carriers out of the apparatus and needed mostly to give charge carriers sufficient kinetic energy to pass through the dense layer of atmosphere. Passed that, the electric field of the planet provides the needed energy for the charge carrier's movement, whereas the magnetic field of the planet provides the direction for the charge carriers movement.

The charge carriers have non-zero mass. Their collision with the air molecules gives momentum to the air, resulting in airflow. The process is known as ionic wind, electric wind, or electronic wind. The air flow of such process follows the path of charge charrier trajectory 402. As the air moves over the land, the air movement brings moisture inland from regions having more pronounced moisture content to regions having less pronounced moisture content. The redistribution of the moisture occurs around the planet along trajectory 402, where areas less humid along trajectory 402 and areas adjacent to trajectory 402 become more humid.

In this embodiment, the rain or mist is created by air condensation. In a non-limiting example, the areas close to the continental shores may contain 80% relative humidity at ambient temperature of 40° Celsius. The dew point for such a condition, or temperature at which the air begins to condense forming water droplets, is about 36° Celsius. The ambient air temperature depends on elevation. The ambient air temperature decreases by a few degrees Celsius per hundred meters of elevation. In this embodiment, the air containing moisture is forced to a higher elevation (see FIG. 4, trajectory 402) and cooled there to the dew point forming water droplets, which fall to the ground in the form or rain or mist along trajectory 402.

As released from the apparatus, the charge carriers move eastward from the location Gan-Eden 405 when released from the apparatus due to the direction of the Lorentz forces acting on the charge carriers. As such, the ionic wind and airflow brings moisture and rain eastward of the location 402, likely causing inundation of the major rivers in the area (e.g. rivers in North Africa and Middle East) as well as inundation of other rivers close or nearby trajectory 402.

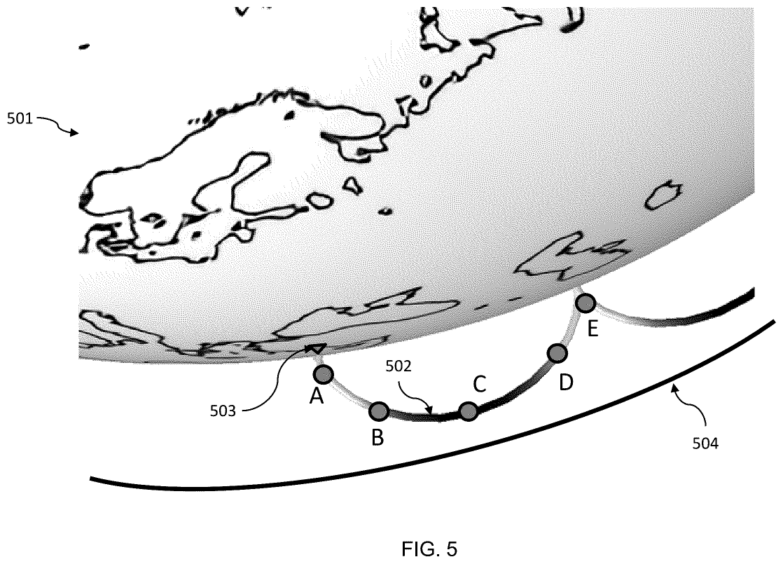

Now referring to FIG. 5, one segment of charge carrier trajectory 502 is shown along with planet 501. As the charge carriers emerge from apparatus 503 and move through the ambient air, they collide with the neutral air molecules, referred as point A. The collision of the charge carriers with the neutral air molecules creates a mix of elementary particles, e.g., positive and negative ions, at the point or points of collision. The larger ions with larger mass drift toward upper layer of atmosphere or the planet surface depending on their charge polarity. The elementary charge carriers (e.g. electrons), which have smaller mass and inertia move along trajectory 502. As the charge carriers reach higher elevation and move closer to ionosphere 504 and moving toward point B, they will undergo less collision with the air molecule due to reduction in the density of the air at higher elevation. This allows for the charge carriers to attain higher velocity and kinetic energy between point A and B, thus at collision events, the charge carriers will have sufficient energy to ionize and free additional charge carriers from air atoms at collision. From point B to C, the air density becomes less, and the charge carriers attain a higher speed than near point B, their collision results in the release of additional charge carriers from atoms at collision. At point C the speed of the charge carriers is the highest. As the charge carriers pass point C and move toward point D, they start slowing down due to the negative force of the planet electric field on the charge carrier's acceleration. Along a segment A to E, the collision of the charge carriers with the neutral air molecules and atoms, causes ionization and, as a result, an increase in the number of charge carriers in a segment from point A to E and subsequent segments. There is only one apparatus needed for the process; however, additional apparatus may be placed along trajectory 402 to increase the amount of charge carriers in the process.

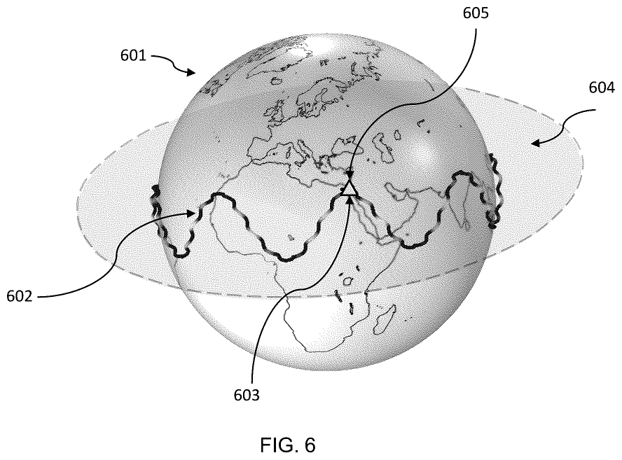

FIG. 6 shows planet 601 and trajectory of charge carriers 602 around planet 601, In this embodiment, apparatus 603 is located at location 605 and is north of the plane of magnetic equator 604. Trajectory of the charge carriers 602 in such embodiment attain wave component, allowing to control the flow of the charge carriers through the regions of the planet, not directly aligned with the magnetic equator planet. The amplitude of trajectory 602 is altered with respect to 402 and depends on how far north or south apparatus 603 is located with respect to the magnetic equator. Generally, the amplitude of trajectory 602 increases as the distance between apparatus 603 and magnetic equator 604 is increased. Thus, the region for precipitation is extended to areas further south or north from magnetic equator 604 of the planet 601. With the apparatus located at or close to 23.5 degrees of north Latitude and the magnetic equator mostly aligned with the planet's equator, the trajectory of the charge carriers is mainly contained between tropics of Cancer and Capricorn (see FIG. 6), also known as Torrid zone. Thus, the apparatus brings precipitation to this zone.

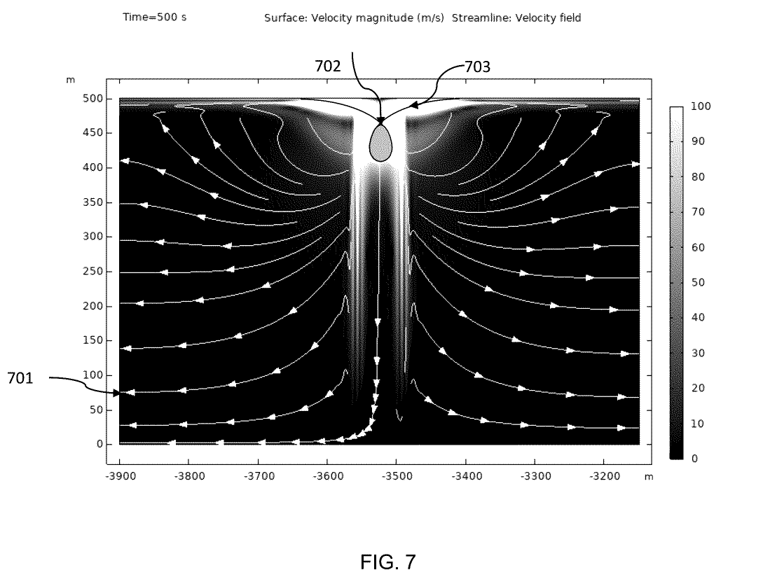

FIG. 7 illustrates the air velocity from point E 702, subsequently referred as an egg, downward to the surface of the planet. As the charge carriers move along the arc segment from point B to E (see FIG. 5, 502, shown as 703 on FIG. 7), the trajectory of the charge carriers gradually changes from horizontal to radial where, the charge carriers move at almost right angle from point E toward the surface of the planet. At point E (see FIG. 7) and all subsequent “eggs” similar to E around the planet, the charge carriers impose pressure at mostly right angle from point E to surface of the planet. Air circulation 701 has a closed path starting from point E toward the surface of the planet and coming back toward point E, creating eddies. The air movement is forced by pressure built at point 702 of the charge carriers having non-zero speed and mass, giving momentum to the air molecules at the collision.

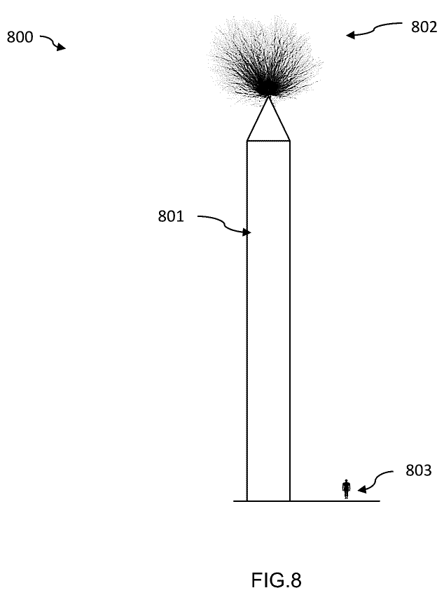

FIG. 8 is a front view of an embodiment of the present invention. In this embodiment, apparatus 800 contains structure 801. Structure 801 is made of material allowing for ion or electron conductivity. For example, metal may be used, or masonry material, such as limestone (CaCO3) saturated in water, may be used. Structure 801 is placed near or under trajectory of the charge carriers 402, whereas the concentration of charge carriers at the sharp curvature or the tip of structure 801 causes the ionization of the air around the tip point, creating plasma discharge and light 802, also known as St. Elmo's fire. Person 803 is standing next to the structure 801.

In another embodiment, the apparatus is utilized to form a light along trajectory 402 as an alternative to the outdoor lights around the planet. In such embodiment, the charge carriers moving along trajectory 402, colliding with air molecules, exciting those, which are normally deexcited releasing photons with the light colors depending on the type of atoms they collide with but normally varying between green, blue, and violet. The light looks similar to the aurora borealis glow or similar to plumbed, feathered or rainbow serpent. Such light is created along trajectory 402 or trajectory 602 in the embodiment.

In another embodiment, the apparatus is utilized to slow down the thinning ice caps due to global warming climate impact. The apparatus is positioned on the planet away from the magnetic equator as described in one of the other embodiments such that trajectory of the charge carriers and their flow may have wave component similar to trajectory 602, allowing the airflow to bring moisture to the polar region of the planet, where precipitation would occur in the form of snow. Accumulation of the precipitation in the form of snow over extended period of time would help recover or slow down the thinning ice caps.

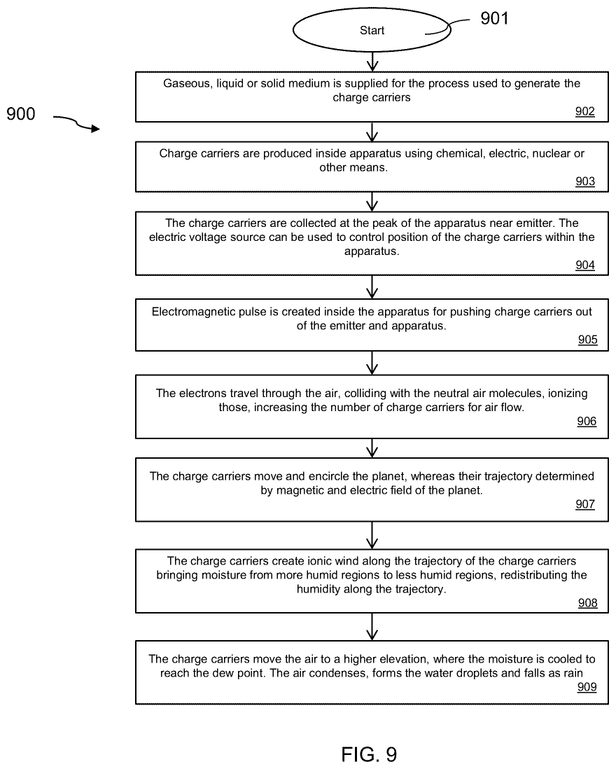

FIG. 9 is a flowchart of a method for weather modification and precipitation enhancement of an embodiment of the present invention. Method 900 begins at block 901.

At step 902, the medium is supplied for the process to generate charge carriers.

At step 903, an apparatus produces charge carriers, using chemical, electric, nuclear, or other means.

At step 904, a dedicated voltage source inside the apparatus imposes an electric field, directing the charge carrier toward the emitter, where the charge carriers are collected.

At step 905, an electromagnetic device accelerates the charge carriers that are released from the emitter.

At step 906, the charge carriers released by the apparatus collide with charge-neutral molecules, positive ions, and negative ions to produce more charge carriers.

At step 907, the charge carriers move along a trajectory determined mostly by the electric and magnetic field of the planet and the location of the apparatus with respect to the plane of the magnetic equator.

At step 908, the charge carriers create ionic wind, also known as electric wind, which give momentum to the neutral air molecules in the direction of the charge carriers flow. The air molecules pick up moisture as they encircle the planet and distribute the moisture along the trajectory of the charge carrier flow.

At step 909, the air molecules bring moisture to the higher layer of the atmosphere, where the air condenses and fall as rain or mist or snow or hail.

The process flow diagram is not intended to indicate that the operations of method 900 are to be executed in any particular order, or that all of the operations of method 900 are to be included in every case. Additionally, method 900 may include any suitable number of additional operations.

A detailed description of one or more embodiments of the disclosed apparatus and method are presented herein by way of exemplification and not limitation with reference to the Figures.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made, and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

Although the invention has been explained in relation to its preferred embodiment, it is to be understood that many other possible modifications and variations can be made without departing from the spirit and scope of the invention.

What is claimed is:

1. An apparatus for enhancing precipitation or weather modification, comprising:
a structure, configured to emit a plurality of charge carriers from an emission node;
a chamber, configured to create the plurality of charge carriers, wherein the chamber is connected to the emission node through a means capable of carrying charge carriers, the chamber comprising:
a channel, connected to supply a medium for creation of the plurality of charge carriers, wherein the medium is one of gaseous, liquid, or solid form;
a device, configured to ionize the medium to produce charge carriers;

2. The apparatus of claim 1, wherein a layer of insulation surrounds the structure to prevent the plurality of charge carriers from leaking through one or more sides of the structure.

3. The apparatus of claim 1, wherein a voltage source is configured to force the plurality of charge carriers to gather close to the emission node.

4. The apparatus of claim 1, wherein the structure is further configured to hold:
one or more electromagnetic devices inside the chamber, the one or more electromagnetic devices configured to accelerate said charge carriers out of the emission node.

5. The apparatus of claim 1, wherein the structure is further configured to hold:
a channel connected to the chamber and extending outside the structure to supply oxygen to the chamber;
one or more piezoelectric devices configured to accelerate the plurality of charge carriers out of the emission node.

6. A method for precipitation enhancement or weather modification comprising:
producing a plurality of charge carriers within an apparatus; and
releasing the plurality of charge carriers from the apparatus.

7. The method of claim 6, wherein producing the plurality of charge carriers further comprises:
using ionization of a medium, wherein the medium is one of gaseous, liquid, or solid form.

8. The method of claim 6, wherein producing the plurality of charge carriers further comprises:
using chemical, electric, nuclear, or other means.

9. The method of claim 6, further comprising:
collecting the plurality of charge carriers at an emitter of the apparatus.

10. The method of claim 6, further comprising:
creating an electromagnetic pulse;
accelerating the plurality of charge carriers with the electromagnetic pulse; and
ejecting the plurality of charge carriers from the apparatus.

11. The method of claim 10, further comprising:
using an electric voltage source to force charge carriers to the emitter.

12. The method of claim 10, further comprising:
using a piezoelectric effect to create the electromagnetic pulse.

13. The method of claim 10, further comprising:
using an electric pulse source to create the electromagnetic pulse.

14. The method of claim 6, further comprising:
moving the plurality of charge carriers in a trajectory around a planet, wherein the trajectory is defined by a magnetic and electric field of the planet.

15. The method of claim 6, further comprising:
accelerating the plurality of charge carriers as defined by an electric field of a planet.

16. The method of claim 6, further comprising:
increasing the density of the plurality of charge carriers through collision with atoms or ions present in the atmosphere.

17. The method of claim 6, further comprising:
creating an ionic wind with a flow of the plurality of charge carriers.

18. The method of claim 14, further comprising:
creating air flow with the ionic wind; and
redistributing moisture along a trajectory of the flow of the plurality of charge carriers.

19. The method of claim 6, further comprising:
using the plurality of charge carriers to move air saturated with moisture to a higher elevation, wherein the air is cooled and condensed, releasing attained moisture as precipitation.

20. The method of claim 19, further comprising:
using the released moisture to enhance precipitation along a trajectory of the plurality of charge carriers.

21. An apparatus for creating light, comprising:
an apparatus configured to release a plurality of charge carriers.

22. The apparatus of claim 21, further comprising:
a plurality of structures distributed on a planet along a path of flow of the charge carriers, wherein the structures have a profile shaped for concentrating an electric field at least one point of the structure and for emitting St. Elmo's fire light.

23. The apparatus of claim 21, wherein the plurality of charge carries encircle a planet, collide with air molecules to ionize the air molecules, and create aurora type light along a path of flow of the charge carriers.

24. An apparatus for slowing down a rising sea level, comprising:
an apparatus configured to release a plurality of charge carriers.

25. The apparatus of claim 24, wherein the plurality of charge carriers flows along a radial path with respect to an equator of the planet, move moisture to one or more polar regions of the planet, and create snowfall in the one or more polar regions of the planet, wherein the snowfall helps reduce thinning ice caps, slows down rise or lowers sea levels by capturing frozen water in one or more ice cap regions of the planet.
